(19) United States
(12) Patent Application Publication
(10) Pub. No.: US 2009/0176683 A1
(43) Pub. Date: Jul. 9, 2009

(54) EFFERVESCENT DETERGENT DISPENSER KIT AND METHOD

(75) Inventors: Christian J. Choe, Grand Rapids, MI (US); Herbert J. Vanderbilt, Lowell, MI (US); Kevin Haley, Byron Center, MI (US); Charles A. Reed, JR., Rockford, MI (US); Eric J. Hansen, Ada, MI (US)

Correspondence Address: MCGARRY BAIR PC, 32 Market Ave. SW, SUITE 500, GRAND RAPIDS, MI, 49503, US

(73) Assignee: BISSELL HOMECARE, INC., Grand Rapids, MI (US)

(21) Appl. No.: 12/339,113

(22) Filed: Dec. 19, 2008

Related U.S. Application Data
(60) Provisional application No. 61/019,060, filed on Jan. 4, 2008.

(51) Int. Cl. C11D 7/38; C11D 17/00; B65D 83/66

(52) U.S. Cl. 510/378; 510/445; 510/375; 222/145.5; 222/635; 222/325; 222/402.1; 222/1

(57) ABSTRACT

A kit and method for preparing a cleaning solution for delivery under pressure includes combining a cleaning composition, an oxidizing agent, an effervescent agent and an aqueous medium in a pressurizable container having an opening with a removably mounted cap. The effervescent agent reacts with the aqueous medium to generate a gas to pressurize the cleaning solution within the container. The method can be used for preparing a cleaning solution for use with a pressurizable container have an aerosol valve assembly or an extraction cleaner with a fluid delivery system for dispensing the cleaning solution under pressure to a surface to be cleaned. The cleaning solution and a pressurizable container having a removably mounted cap with an aerosol valve assembly can be provided as a kit to a consumer for preparing a pressurized cleaning solution.

### CROSS REFERENCE TO RELATED APPLICATIONS

This application claims the benefit of U.S. Provisional Application Ser. No. 61/019,060, filed Jan. 4, 2008, entitled “Effervescent Detergent Dispenser”.

### BACKGROUND OF THE INVENTION

1. Field of the Invention

This invention relates to a pressurized cleaning solution. In one of its aspects, the invention relates to a pressurizable container with an aerosol dispensing valve for dispensing a cleaning solution as an aerosol spray onto a surface to be cleaned. In another of its aspects, the invention relates to an extraction cleaner having a fluid delivery system for improving fluid distribution onto a surface being cleaned.

2. Description of the Related Art

An aerosol dispenser is a type of dispensing system that creates an aerosol mist of liquid particles and has been well known in the prior art for many years. Aerosol dispensers have been used in a vast number of commercial applications, for example, in pressurized cans or bottles containing insecticides, paints, cleaners, or a multitude of other liquid products. The most common current propellant systems utilize blends of propane, butane, and isobutane. Additional propellants include dimethyl ether (also known as DME), carbon dioxide, nitrogen, and fluorinated hydrocarbons (HFC). These aerosol compositions are typically packaged in metal containers that can withstand high internal pressures that result from increased gas pressures caused by high temperatures encountered during product storage or transit.

Compositions containing reactive components, such as hydrogen peroxide, for example, provide significant packaging and storage challenges. The dispenser system disclosed in U.S. Pat. No. 7,021,499 to Hansen et al., provides a system for stably storing and dispensing a cleaning composition and hydrogen peroxide to remove stains comprising two pressurized aluminum containers, one each for storing and dispensing the cleaning composition and the peroxide, respectively. Reactive components such as hydrogen peroxide improve the cleaning performance of the cleaner; dispensing under pressure as an aerosol further augments the cleaning performance.

Aerosol dispensers can be costly to produce and transport due to the nature of the pressurized liquid and the types of containers used. The aluminum containers typically used for packaging pressurized liquids provide safe packaging for liquids under pressure, but are also heavier than other types of container packaging, such as plastic. Aluminum containers can also be more costly to manufacture. The dual dispenser described in U.S. Pat. No. 7,021,499 comprises two pressurized aluminum containers, which can double the manufacturing and transport costs.

Manual trigger spray bottles for dispensing detergent solutions are used to avoid the expense of an aluminum aerosol package. Both aerosol cans and spray bottles are typically filled by manufacturers and then sold to consumers at the point-of-sale. The contents are used by the consumer and the aerosol can or spray bottle is then disposed of.

However, with today's emphasis on environmental consciousness, it is highly desirable to promote the re-use of products that maintain their utility. Manual trigger spray bottles can be provided to consumers as re-usable, re-fillable products. Many manufacturers are currently selling chemistry concentrates to be used to re-fill conventional spray bottles. Re-using a spray bottle minimizes the number of spray bottles that are disposed of, decreasing waste. Providing the chemistry to the consumer as a concentrate also minimizes transport costs because the producer is not paying to transport all of the water that is used to dilute the concentrate.

While there are several products available providing re-usable, re-fillable manual trigger spray bottles, there remains a need to provide a re-usable, rechargeable aerosol dispensing system for use by a consumer.

U.S. Pat. No. 2,331,117 to Goodhue et al. discloses a dispensing apparatus adapted to hold a liquid under pressure and a spray device for dispensing the liquid, of means for separating out a predetermined quantity of liquid in the container and expelling with the spray device this predetermined quantity as a unit dose so that each dose dispensed will be exactly the same. When the liquid is of a type containing a component volatile at ordinary room temperature, such as dichlorodifluoromethane, carbon dioxide, and methylbromide, the gas produced in the container by volatilization maintains sufficient pressure therein to expel the liquid from the pocket through the tube and the nozzle when the valve is open, from whence it volatilizes or atomizes into the atmosphere. However, gas under pressure from an external source may be introduced through a valve also.

U.S. Pat. No. 6,540,109 to Klima et al. discloses rechargeable spray bottle dispensers that can be recharged or refilled with one or more reservoirs containing a chemical concentrate and water or some other suitable solvent.

U.S. Pat. No. 5,507,420 to O'Neill discloses a reusable high efficiency propellant driven dispenser for the dispensing of liquids that includes a refillable container and a rechargeable propellant housing. The propellant housing can be moved from container to container to dispense a propellant into each container. The dispenser includes a pressurized liquid propellant chamber that is initially charged with a quantity of a highly compressed gas.

### SUMMARY OF THE INVENTION

According to the invention, a kit for preparing a cleaning solution comprises a pressure resistant container, a cleaning solution having a first component comprising a cleaning composition, a second component comprising at least one oxidizing agent and a third component comprising at least one effervescent agent. A dispensing valve assembly is mounted on the top of the container, and the cleaning solution is dispensed through the valve assembly under pressure. The cleaning solution is mixed with an aqueous medium in the container, and then the valve assembly is placed on the container. The effervescent agent reacts with the aqueous medium to produce a gas to pressurize the container to dispense the cleaning solution in a pressurized spray.

According to another embodiment of the invention, a method for preparing a cleaning solution comprises adding a first component comprising a cleaning composition, a second component comprising at least one oxidizing agent, a third component comprising at least one effervescent agent and an aqueous medium to a pressurizable container. The method further involves replacing a removable cap on the container, the cap including an aerosol valve assembly for dispensing the cleaning solution under pressure from the container. The effervescent agent in the third component reacts with the aqueous medium to produce a gas to pressurize the cleaning solution within the container.

According to yet another embodiment of the invention, a method of cleaning a stain on a surface comprises preparing a cleaning solution by adding a cleaning composition, at least one oxidizing agent and at least one effervescent agent and an aqueous medium to a pressurizable container. The method further involves replacing a removable cap on the container, the cap including an aerosol valve assembly for dispensing the cleaning solution under pressure from the container. The cleaning solution dissolves the stain and then the soiled solution is recovered. The effervescent agent in the third component reacts with the aqueous medium to produce a gas to pressurize the cleaning solution within the container.

According to another embodiment, a method for preparing a cleaning solution for use with an extraction cleaner comprises combining a first component comprising a cleaning composition, a second component comprising at least one oxidizing agent, a third component comprising at least one effervescent agent and an aqueous medium in the fluid delivery tank. Reacting the effervescent agent with the aqueous medium to generate a gas that pressurizes the fluid delivery tank. The pressure generated within the fluid tank helps to force detergent through the fluid delivery system and onto the cleaning surface when the fluid delivery valve is selectively actuated by a user via a trigger and push rod assembly.

The cleaning composition can include one or more of the following: a cleaning solvent, a surfactant, an anionic polymer, a stabilizer, a builder, an organic acid and any combination thereof.

The oxidizing agent can be at least one of a preformed peracid compound selected from the group consisting of hydrogen peroxide, percarboxylic acid and salts, percarbonic acids and salts, perimidic acids and salts, peroxymonosulfuric acids and salts, and mixtures thereof, a persalt and a peroxide compound.

The effervescent agent can be a mixture of at least one acid or a salt of an acid and at least one base or a salt of a base that react to produce a gas. The effervescent agent can also be a mixture of a catalyst and a peroxygen compound or a peroxygen forming compound that react to produce a gas. The catalyst can be in form of a metal or a base.

The cleaning solution can be in the form of a concentrated powder, tablets or a gel. The cleaning solution can also be packaged in a water-soluble pouch. All three components of the cleaning solution can be packaged together or at least one component can be packaged individually. At least the third component comprising the effervescent agent is in a dry form.

The invention provides a cleaning solution comprising an effervescent agent for pressurizing the cleaning solution for delivery onto a surface to be cleaned under pressure from an aerosol spray dispenser or a fluid delivery system of an extraction cleaner.

### BRIEF DESCRIPTION OF THE DRAWINGS

In the drawings:

FIG. 1 is a perspective view of an effervescent detergent dispensing system according to the invention.

FIGS. 2A and 2B are cross-sectional views of the effervescent detergent dispensing system according to the invention taken along line 2-2 of FIG. 1.

FIG. 3 is a perspective view of an extraction cleaner according to another embodiment of the invention.

FIG. 4 is an exploded perspective view of a solution tank of FIG. 3.

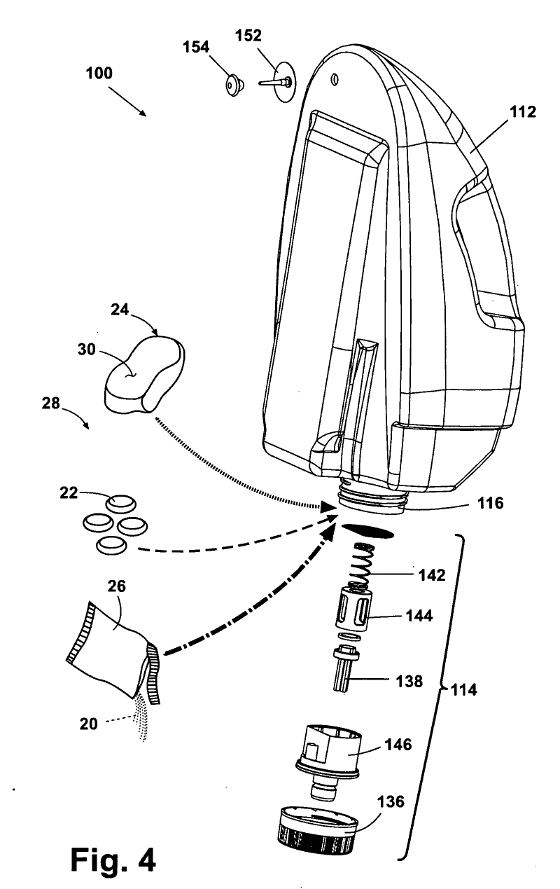

### DESCRIPTION OF THE PREFERRED EMBODIMENTS

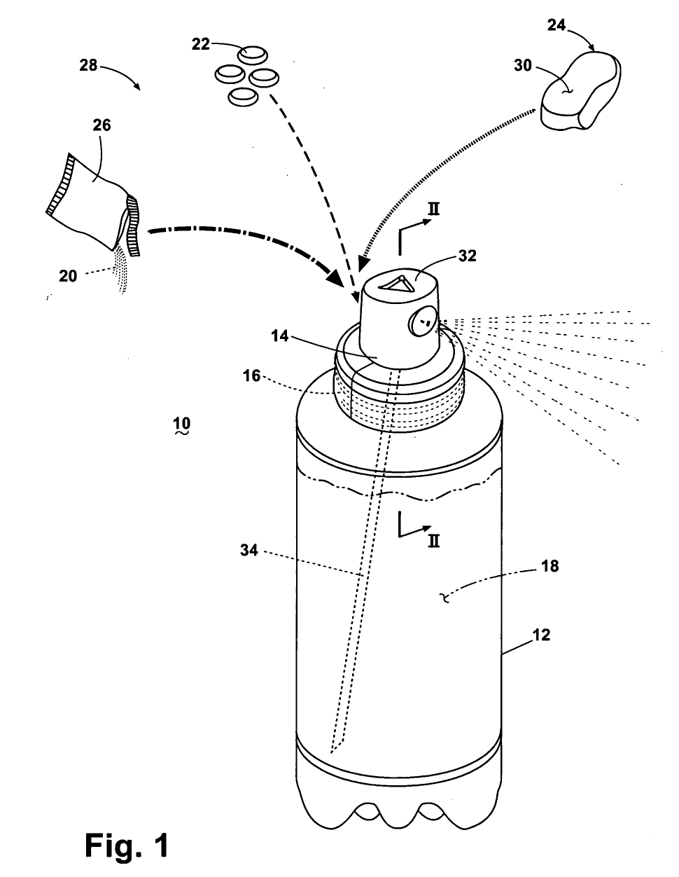

Referring to FIG. 1, an effervescent detergent dispensing system 10 according to the present invention is illustrated. The dispensing system 10 can be used for dispensing cleaning solution onto a surface to be cleaned and comprises a reusable self-pressurizing container 12 and a cleaning solution 18. An aerosol valve assembly 14 is mounted on the top of the container 12, and the cleaning solution 18 is dispensed through the valve assembly 14 in a similar fashion as conventional aerosol sprayers with a propellant.

The container 12 is preferably made from plastic and has an open end 16. Material selection for the container depends upon the type of effervescent agent and composition utilized in the cleaning solution 18. Pressurization within the container 12 can range from 20 to 100 pounds per square inch (psi) with a preferred range of 40 to 60 pounds per square inch (psi). The invention is not limited to pressurization within these ranges, but can vary depending on the type of container, the cleaning solution and the application.

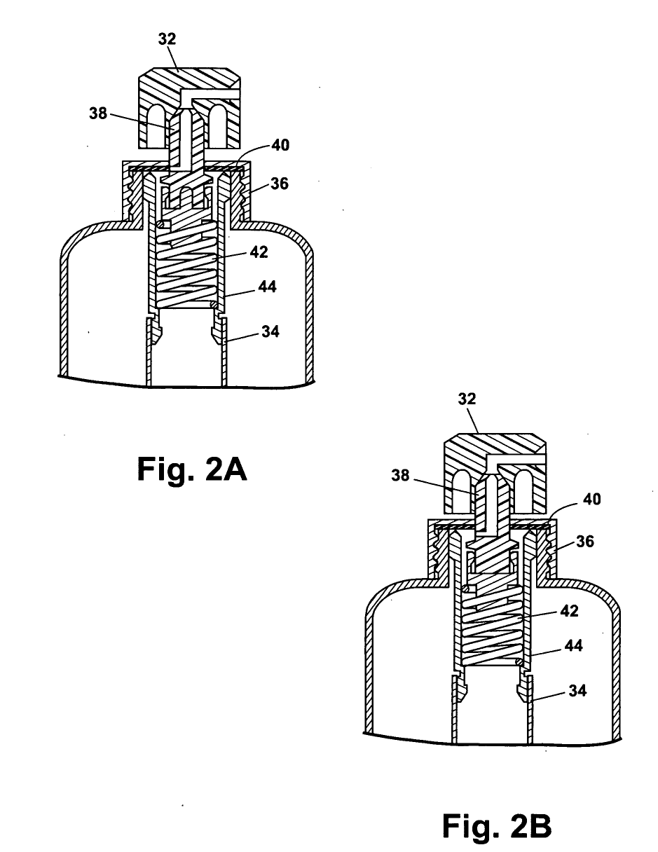

Referring to FIGS. 2A and 2B, the valve assembly 14 comprises a spray head actuator 32, a threaded cap 36, a stem 38, a gasket 40, a spring 42, a valve housing 44, and a dip tube 34. The spray head actuator 32 assembles to the stem 38 through a slight friction fit between the outside diameter of the stem 38 and the inner coaxial diameter of the spray head actuator 32. The stem 38 extends through an orifice in the threaded cap 36, an orifice in the gasket 40, and into the open end of the valve housing 44. The gasket 40 is located between the threaded cap 36 and the open end of the valve housing 44 and provides a seal between the two components 36, 44. The coil spring 42 is located within the valve housing 44 and the end of the stem 38 is located within the diameter of the coil. The dip tube 34 is connected with the bottom of the valve housing 44 by a snap-fit, or any other suitable means. The spray head actuator 32, stem 38 and dip tube 34 are all in fluid communication. Preferably, the threaded cap 36 is internally threaded to removably mount the valve assembly 14 to the externally threaded open end 16 of the container 12. Other suitable methods of mounting the valve assembly 14 to the container 12 may be possible. The invention is not be limited to the type of valve assembly 14 described herein, and other valve assemblies well known to those skilled in the art can be utilized with the aerosol dispenser.

Preferably, the cap 36 includes a pressure relief valve (not shown) that will open in the event that the pressure within the container 12 exceeds a predetermined value. Pressure relief valves are well known and can include a re-settable system or a one-time use system. One-time use systems are preferred so that repeated intentional misuse is prevented. The pressure relief valve can be a valve that is held by force, such as a spring, and breaks the seal when pressure inside the bottle reaches a predetermined limit. Alternatively, a collar or other part can be designed so that it will break when the bottle is over pressure.

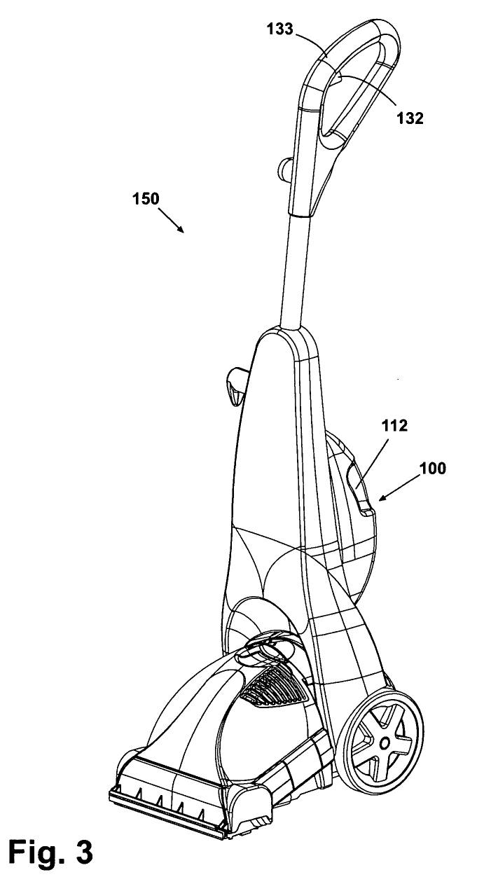

FIG. 3 illustrates a second embodiment of the invention comprising an effervescent dispensing system 100 that is similar to the effervescent system 10 except for that it is used with an extraction cleaner. Therefore, elements in the dispensing system 100 that are similar to the dispensing system 10 will be numbered with the prefix 100.

The effervescent dispensing system 100 comprises a supply tank 112 for use with an extraction cleaner 150 for delivering a cleaning solution 18 to a surface to be cleaned. The extraction cleaner 150 can have a suitable gravity-fed fluid delivery and recovery system for delivering the cleaning solution 18 from the supply tank 112 to a surface to be cleaned and for recovering the soiled solution. Such a suitable fluid delivery and recovery system is disclosed in U.S. Pat. No. 6,658,692 to Lenkiewicz et al. which is incorporated herein by reference in its entirety.

The supply tank 112 can be molded from translucent or transparent thermoplastic material and includes a valve assembly 114 for selectively delivering the cleaning solution 18 to the fluid delivery system of the extraction cleaner 150. The valve assembly 114 comprises a feed valve 146 sized for receipt within a threaded opening 116 of the supply tank 112. The feed valve 146 is held in place by a valve retainer ring 136 with threads that mate with the threads on the opening 116. The valve assembly 114 further includes a valve housing 144 having a valve plug 138 that is biased against the feed valve 146 by a spring 142. The valve assembly 114 is arranged to be selectively actuated by a push rod assembly (not shown) in connection and operable by a user via a trigger mechanism 132 located within a handle 133 of the extraction cleaner 150. The push rod assembly has a pin (not shown) that presses valve plug 138 against the spring bias, thereby opening the feed valve 146.

The supply tank 112 may further provided with a pair of internal and external umbrella valves 152, 154 mounted to an inner and outer surface of the supply tank 112, respectively. The umbrella valves 152, 154 provide venting for the supply tank 112 in the event that the pressure within the supply tank 112 exceeds a predetermined threshold.

The cleaning solution 18 can comprise a mixture of a solvent and a cleaning solution concentrate 28 and can be used to remove stains and soil from the surface to be cleaned. Water is preferred as the solvent, particularly de-ionized or reverse osmosis water because it prevents contamination of the cleaning solution 18 by trace minerals found in tap water. De-ionized or reverse osmosis water also evaporates with little or no residue after delivery of the cleaning solution 18 to the surface to be cleaned.

The cleaning solution concentrate 28 consists of one or more cleaning agents, one or more oxidizing agents and one or more effervescent agents that are preferably soluble in the solvent. The effervescent agent is preferably stored in a dry form prior to mixing with the solvent. The cleaning agents, oxidizing agents and effervescent agents can be provided as a single concentrate or as one or more separate concentrates.

The cleaning agent can include one or more of the following: a cleaning solvent, a surfactant, an ethoxylated fatty alcohol, anionic surfactant, amine oxide, amphoteric, or zwitterionic surfactant. Preferably, the cleaning agent is comprised of a nonionic surfactant.

The oxidizing agent can include one or more of the following: a preformed peracid compound selected from the group consisting of hydrogen peroxide, percarboxylic acid and salts, percarbonic acids and salts, perimidic acids and salts, peroxymonosulfuric acids and salts, and mixtures thereof, a persalt and a peroxide compound. Non-limiting examples of persalt compounds include perborate compounds, percarbonate compounds, perphosphate compounds, percarbamide compounds and mixtures thereof. According to one embodiment of the invention, the oxidizing agent is hydrogen peroxide. According to another embodiment, the oxidizing agent can be selected from the group comprising of perborate compounds, percarbonate compounds, perphosphate compounds, percarbamide compounds and mixtures thereof.

The effervescent agent comprises an acid source and an alkali source, which upon contact with a solvent reacts to provide gas, creating the effervescent action. The effervescent agent is preferably sodium bicarbonate and citric acid, but other reactive ingredients can be used. It is known in the prior art that effervescent action promotes the rapid release of detergents into the solvent so as to provide improved cleaning performance. Alka-Seltzer® is an example of an effervescent composition. A further example can be found in U.S. Pat. No. 1,427,979 to Stokes, which is incorporated herein by reference in its entirety.

Non-limiting examples of an effervescent agent includes one or more of the following: sodium bicarbonate, sodium carbonate, or sodium carbonate peroxyhydrate, and citric acid, or malic acid.

According to another embodiment of the invention, the effervescent agent can comprise a catalyst and hydrogen peroxide, which also beneficially acts as an oxidizing agent. It is known in the prior art that hydrogen peroxide and a catalyst react to produce water and oxygen gas, thus creating the effervescent action. Possible catalysts include transition metals such as iron, copper, zinc etc. along with manganese, iodine and metal alkali such as sodium hydroxide together with weak organic bases such as ammonium hydroxide. For example, ammonia, Versenex 80 (commercially sold by The Dow Chemical Company) and sodium hydroxide can all be used as catalysts to react with the hydrogen peroxide to generate a gas.

The cleaning solution concentrate 28 can further comprise one or more additives, such as: a fragrance, a colorant, a surfactant(s), a stabilizer, solvents, acrylic copolymers, or polymeric materials to function as binders or any combination thereof.

The cleaning solution concentrate 28 can be stored in several different forms. In the first form, the cleaning solution concentrate 28 is a powder 20, which can be packaged for sale to the user in an individual, or multiple-use, pre-measured packet 26. The packet 26 can be made of moisture resistant paper laminate containing wax, polyethylene, foil or polyester layers, or any other suitable material. The consumer can rip the top off the packet 26 and pour the powder 20 into the container 12 or the supply tank 112 for mixing with a solvent.

In a second form, the cleaning solution concentrate 28 can be a tablet 22. The consumer adds one or more tablets 22 to the container 12 or the supply tank 112 for mixing with a solvent.

In a third form, the cleaning solution concentrate 28 can be in a gel 30 and can be packaged in a water-soluble pouch 24. The pouch can be made of a water-soluble material that dissolves on contact with water or another solvent medium to release the gel 30, such as polyvinylalcohol or polyvinyl acetate. The consumer adds one or more pouches 24 to the container 12 or the supply tank 112 for mixing with a solvent. The pouch 24 dissolves in the solvent, releasing the cleaning solution concentrate 28 into the water, forming the cleaning solution 18.

While the cleaning concentrate 28 has been described as a single article containing all three components, the cleaning agents, oxidizing agents and effervescent agents, the cleaning concentrate 28 can also be provided as multiple articles, each containing one or more of the components for adding individually to the container 12 or supply tank 112 for mixing with a solvent. In this manner, each component can be packaged in the most suitable form and combination depending on its composition and stability.

For example, the cleaning agent and oxidizing agent can be packaged as a first article that can be combined with an effervescent agent packaged as a second article for mixing with a solvent. The cleaning agent and oxidizing agent can be in the form of a concentrated gel while the effervescent agent is in the form of a tablet. Alternatively, each component can be packaged as a single article and each of the three articles can be added to the container 12 or supply tank 12 individually for mixing with a solvent.

A method according to an embodiment of the invention will now be described for preparing a cleaning solution 18 for spraying onto a surface to be cleaned. To make the cleaning solution 18, the user adds the cleaning solution concentrate 28 to the container 12 through the open end 16 for mixing with a solvent. The user then replaces the valve assembly 14 on the container 12.

When mixed with the solvent, the cleaning solution concentrate 28 dissolves to form the cleaning solution 18. The effervescent agents contained within the cleaning solution concentrate 28 also react upon contact with the solvent to form a volatile gas. This volatile gas, when released into the closed effervescent dispensing system 10, generates pressure to dispense the cleaning solution 18 in an aerosol spray. An example of this type of dispensing system can be found in U.S. Pat. No. 2,195,554 to Beardsley, which is incorporated herein by reference in its entirety. When the cleaning solution 18 is made, the dispensing system 10 can be used to dispense the cleaning solution 18 onto a surface to be cleaned in the manner described above.

To dispense the cleaning solution 18, the user grips the container 12 and depresses the spray head actuator 32 to dispense the cleaning solution 18 in an aerosol spray. The downward pressure on the spray head actuator 32 and associated stem 38 compresses the spring 42 and opens a fluid passageway. The pressure in the container 12 forces the cleaning solution 18 through the dip tube 34, into the stem 38, and out the spray head actuator 32 in a spray pattern to spray on a surface to be cleaned, such as a carpet, rug, upholstery, or other fabric or hard surface. When the user releases the pressure on the spray head actuator 32, the fluid passageway closes and the cleaning solution 18 ceases to spray out.

According to another embodiment of the invention, the cleaning solution 18 can be used with an extraction cleaner 150. The cleaning solution 18 for use in an extraction cleaner 150 can be made in a similar way to the cleaning solution 18 for use in the container 12. A user can place a cleaning solution concentrate 28 containing an effervescent agent in the supply tank 112 together with a suitable solvent. The user can add the cleaning solution concentrate 28 and solvent to the supply tank 112 through the opening 116 and replace the valve assembly 114. Alternatively, the supply tank 112 can be provided with a separate opening for receiving the cleaning solution concentrate that can be sealed with a cap (not shown).

When mixed with the solvent, the cleaning solution concentrate 28 dissolves to form the cleaning solution 18. The effervescent agents contained within the cleaning solution concentrate 28 also react upon contact with the solvent to form a volatile gas. This volatile gas, when released into the closed effervescent dispensing system 100, generates pressure to dispense the cleaning solution 18. The combination of chemicals generates a volatile gas which pressurizes the supply tank 112. A pressurized supply tank 112 can improve the performance of a simple gravity-fed fluid delivery system, such as that used with the extraction cleaner 150 or can eliminate the need for costly pump assemblies required in more complex fluid delivery systems.

To deliver the cleaning solution 18 to the surface to be cleaned, the user depresses the trigger 132 mounted in the handle 133, which in turn acts on a push rod (not shown) to open the feed valve 146. The cleaning solution 18 is dispensed from the tank and into the fluid delivery system by gravity and aided by the positive pressure within the supply tank 112 generated by the effervescent agent in the cleaning solution 18.

### SPECIFIC EXAMPLES

All ingredients are listed as percent by weight of the composition.

A first cleaning solution was prepared with the following ingredients:

| INGREDIENTS | % WEIGHT |
|---|---|
| Sodium bicarbonate | 64 |
| Nonionic surfactant | 6 |
| Citric Acid | 30 |
| Total | 100 |

The pH of the cleaning solution was 7.0±0.5.

Other compositions of the cleaning solution 18 set forth below were prepared by mixing ingredients as set forth below and tested. All performed satisfactorily when sprayed onto a stained carpet or upholstery fabric.

A second cleaning solution was prepared with the following ingredients:

| INGREDIENTS | % WEIGHT |
|---|---|
| Sodium Bicarbonate | 56 |
| Nonionic Surfactant | 7 |
| 2-Pyrrolidinone, 1-ethennyl-, | 7 |
| homopolymer; Hydrogen peroxide | |
| Citric acid | 30 |
| Total | 100 |

The invention provides an effervescent dispensing system 10, 100 for delivering a cleaning solution 18 under pressure to a surface to be cleaned. According to a first embodiment of the invention, the effervescent dispensing system 10 includes a reusable self-pressurizing container 12 having an aerosol valve assembly 14 for dispensing the cleaning solution 18 under pressure onto a surface to be cleaned. The pressure for dispensing the cleaning solution 18 is provided by an effervescent agent present in the cleaning solution 18 that reacts with a solvent to generate a gas. The effervescent dispensing system 10 can be made available to the consumer as a starter kit that consists of the container 12, the valve assembly 14, and the cleaning solution 18 in the form of a concentrate 28. The user can mix the concentrate 28 with a solvent in the container 12 to generate the cleaning solution 18 and to produce a gas to pressurize the cleaning solution 18. The concentrate 28 can be provided to the user for refilling and re-pressurizing the container 12. The concentrate 28 can be provided in a variety of forms, including a tablet, a powder and a gel and with different chemistries depending on the desired application.

The effervescent dispensing system 10 disclosed herein, provides an aerosol-type spray cleaner that has a reduced cost to manufacture, as compared to a traditional metal aerosol spray can. Another benefit is the environmental impact; the container 12 is reusable and therefore reduces consumer waste, compared to one-time use systems. In addition, since the solvent can be added by the user after the point of purchase, the effervescent dispensing system 10 reduces shipping weight compared to products that are sold ready-made to the user. Most of these products are over 90% water, therefore, eliminating the solvent from the product offered for sale significantly decreases the overall weight of the product.

According to a second embodiment of the invention, the effervescent dispensing system 100 includes a supply tank 112 for use with an extraction cleaner 150 for delivering the cleaning solution 18 under pressure to a surface to be cleaned. The pressure for dispensing the cleaning solution 18 is provided by an effervescent agent present in the cleaning solution 18 that reacts with a solvent to generate a gas. The cleaning solution 18 can be provided to the user in the form of a concentrate 28 that the user can mix with a solvent in the supply tank 112 to produce a gas pressurize the supply tank 112. The pressurized supply tank 112 can provide improved delivery performance with the extraction cleaner 150 without the use of costly, energy consuming pumps. The concentrate 28 can be provided to the user for refilling and re-pressurizing the supply tank 112. The concentrate 28 can be provided in a variety of forms, including a tablet, a powder and a gel and with different chemistries depending on the desired application.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A kit for preparing a cleaning solution comprising:
a pressurizable container which includes a vessel having an open end and a cap removably mounted to the open end of the container, the cap including an aerosol valve assembly for dispensing a solution under pressure from the vessel;
a cleaning solution having a first component comprising a cleaning composition, a second component comprising at least one oxidizing agent and a third component comprising at least one effervescent agent,
whereas when the cleaning solution is added to the vessel with an aqueous medium and the cap is replaced on the open end of the vessel, the effervescent agent reacts with the aqueous medium to produce a gas to pressurize the container.

2. The kit according to claim 1 wherein the first, second and third components are packaged together in the form of one of a concentrated powder, a concentrated tablet and a concentrated gel.

3. The kit according to claim 1 wherein the cleaning solution is packaged in a water-soluble pouch.

4. The kit according to claim 1 wherein at least the third component is in a dry form.

5. The kit according to claim 1 wherein at least one of the first, second and third components is packaged separately from the other components.

6. The kit according to claim 1 wherein the cleaning composition includes at least one of a solvent, a surfactant, an anionic polymer, a stabilizer, a builder, an organic acid and combinations thereof.

7. The kit according to claim 1 wherein the effervescent agent comprises a mixture of at least one of an acid and a salt of an acid and at least one of a base and a salt of a base that reacts to produce a gas.

8. The kit according to claim 1 wherein the at least one of an acid and a salt of an acid is one of an organic acid and an organic salt.

9. The kit according to claim 1 wherein the effervescent agent comprises a mixture of a catalyst and at least one of a peroxygen compound and a peroxygen forming compound that reacts to produce a gas.

10. The kit according to claim 9 wherein the catalyst is at least one of a metal and a base.

11. The kit according to claim 1 wherein the oxidizing agent is at least one of a preformed peracid compound selected from the group consisting of hydrogen peroxide, percarboxylic acid and salts, percarbonic acids and salts, perimidic acids and salts, peroxymonosulfuric acids and salts, and mixtures thereof.

12. The kit according to claim 1 wherein the oxidizing agent is selected from the group comprising of perborate compounds, percarbonate compounds, perphosphate compounds, percarbamide compounds and mixtures thereof.

13. A method for preparing a cleaning solution comprising:
adding a first component comprising a cleaning composition, a second component comprising at least one oxidizing agent, a third component comprising at least one effervescent agent and an aqueous medium to a pressurizable container having an open end sealable with a removable cap;
replacing the removable cap over the open end of the container, the cap including a dispensing valve assembly for dispensing the solution under pressure from the container; and
reacting the at least one effervescent agent in the third component with the aqueous medium to produce a gas to pressurize the cleaning solution within the container.

14. The method of preparing a cleaning solution according to claim 13 wherein the first, second and third components are added to the container simultaneously in the form of one of a concentrated powder, a concentrated tablet and a concentrated gel.

15. The method of preparing a cleaning solution according to claim 13 wherein the cleaning composition, oxidizing agent and effervescent agent are individually added to the container in the form of one of a concentrated powder, a concentrated tablet, a concentrated gel and a mixture thereof.

16. The method of preparing a cleaning solution according to claim 13 wherein the cleaning solution is packaged in a water-soluble pouch.

17. The method of preparing a cleaning solution according to claim 13 wherein at least the third component is in a dry form.

18. The method of preparing a cleaning solution according to claim 13 wherein at least one of the first, second and third components is packaged separately from the other components.

19. The method of preparing a cleaning solution according to claim 13 wherein the cleaning composition includes at least one of a solvent, a surfactant, an anionic polymer, a stabilizer, a builder, an organic acid and any combinations thereof.

20. The method of preparing a cleaning solution according to claim 13 wherein the effervescent agent comprises a mixture of at least one of an acid and a salt of an acid and at least one of a base and a salt of a base that react to produce a gas.

21. The method of preparing a cleaning solution according to claim 13 wherein the at least one of an acid and a salt of an acid is one of an organic acid and an organic salt.

22. The method of preparing a cleaning solution according to claim 13 wherein the effervescent agent comprises a mixture of a catalyst and at least one of a peroxygen compound and a peroxygen forming compound that react to produce a gas.

23. The method of preparing a cleaning solution according to claim 22 wherein the catalyst is at least one of a metal and a base.

24. The method of preparing a cleaning solution according to claim 13 wherein the oxidizing agent is at least one of a preformed peracid compound selected from the group consisting of hydrogen peroxide, percarboxylic acid and salts, percarbonic acids and salts, perimidic acids and salts, peroxymonosulfuric acids and salts, and mixtures thereof.

25. The method of preparing a cleaning solution according to claim 13 wherein the oxidizing agent is selected from the group comprising of perborate compounds, percarbonate compounds, perphosphate compounds, percarbamide compounds and mixtures thereof.

26. A method of cleaning a stain on a surface comprising:
preparing a cleaning solution according to claim 13;
dispensing the solution under pressure through the dispensing valve assembly onto the stain;
dissolving the stain in the solution; and
recovering the soiled solution.

27. The method of cleaning a stain on a surface according to claim 26 wherein the first, second and third components are added to the container simultaneously in the form of one of a concentrated powder, a concentrated tablet and a concentrated gel.

28. A method for cleaning a surface with an extraction cleaning appliance having a fluid delivery system comprising:
preparing a cleaning solution according to claim 13; and
connecting the dispensing valve assembly of the container with the fluid delivery system of the extraction cleaning appliance.
